(19) United States
(12) Patent Application Publication
(10) Pub. No.: US 2015/0066778 A1
(43) Pub. Date: Mar. 5, 2015

(54) DIGITAL CARD-BASED PAYMENT SYSTEM AND METHOD

(71) Applicant: SAMSUNG SDS CO., LTD., Seoul (KR)

(72) Inventors: Sung-Ho JANG, Seoul (KR); Jung-Mee HWANG, Seoul (KR); Seong-Moon KANG, Seoul (KR); Sang-Hoon HAN, Seoul (KR)

(73) Assignee: SAMSUNG SDS CO., LTD., Seoul (KR)

(21) Appl. No.: 14/474,474

(22) Filed: Sep. 2, 2014

(30) Foreign Application Priority Data
Sep. 2, 2013 (KR) 10-2013-0104782

(51) Int. Cl. G06Q 20/38; G06Q 20/32; G06Q 20/40

(52) U.S. Cl. CPC G06Q 20/3829; G06Q 20/40975; G06Q 20/3226
USPC 705/71

(57) ABSTRACT

Disclosed is a digital card-based payment system and method. A digital card-based payment system includes a seller terminal configured to acquire a token from a purchaser terminal desiring to purchase a product and a card management server configured to store and manage one or more pieces of card information and one or more pieces of token information corresponding to the card information and, upon receipt of the token information and payment information for the product from the seller terminal, make payment for the product using card information corresponding to the received token.

### CROSS-REFERENCE TO RELATED APPLICATION

This application claims priority to and the benefit of Korean Patent Application No. 10-2013-0104782, filed on Sep. 2, 2013, the disclosure of which is incorporated herein by reference in its entirety.

### BACKGROUND

1. Field of the Invention

The present disclosure relates to a payment technology using a digital card.

2. Discussion of Related Art

A digital card system is a mobile payment technology for using a mobile device, such as a smartphone, a tablet PC, and so on, to purchase a product online or offline. Recently, a mobile card, i.e., a digital card, which is stored on a mobile device and configured to perform the same function as an existing plastic card, has attracted attention as a next generation payment means. A digital card system combines a financial transaction with an advanced information technology (IT), thus improving convenience and stability of a mobile card and providing various merits, such as convenience for use, additional discount benefit, etc. to get the spotlight as a next generation payment means.

A mobile card is largely classified into a barcode-based mobile card and a near field communication (NFC)-based mobile card. A barcode-based mobile card converts card information to a form of a visually recognizable code, such as a barcode or quick response (QR) code to perform payment, or converts payment information itself to a barcode or QR code and recognizes the barcode or QR code through a reader stored in the mobile device to make payment. An NFC-based mobile card stores card information in a chipset built in a smartphone of a user, and thus payment is made by bring the NFC-based mobile card in close to a non-contact type terminal.

A barcode-based mobile card is configured to store card information in a purchaser's terminal and allow the terminal to generate a disposable code using the card information upon payment. However, when sensitive data, such as a card number, is stored in a smartphone, the data may be copied or stolen. Furthermore, it is inconvenient in that each time a user should call a card to generate a disposable barcode, which causes a payment process to be delayed. In addition, there are problems in that information security is vulnerable and non-repudiation is impossible because a user authentication or additional encryption function is not provided upon payment by a mobile card.

### SUMMARY

The present disclosure is directed to use a token corresponding to card information and an ID-based public key encryption technology to improve security of a mobile card system and maximize convenience of use.

According to an aspect of the present disclosure, there is provided a purchaser terminal including an information management module configured to receive card information for paying for a product from a user and transmit the card information to a card management server, a code generation module configured to receive a token corresponding to the card information from the card management server, use the received token to generate a visually recognizable code, and provide the generated code to a seller terminal according to the user's request, and a payment confirmation module configured to perform payment confirmation together with the user according to a payment confirmation request of the card management server when the payment for the product is made by the code provided to the seller terminal.

The code generation module may provide the generated code to the seller terminal by displaying the generated code on a screen or transmitting the generated code to the seller terminal through wireless communication with the seller terminal.

The purchaser terminal may further include a security module configured to encrypt a transmission message transmitted to the card management server and decrypt a reception message received from the card management server.

The security module may encrypt the transmission message with an encryption algorithm that uses identification information of the card management server as a public key and decrypt the reception message using a client-side private key generated from the identification information of the purchaser terminal.

The identification information of the card management server may be a network address of the card management server.

The identification information of the purchaser terminal may include one or more of a phone number of the purchaser terminal, a serial number of the purchaser terminal, and an identity (ID) of the user.

The payment confirmation request may be encrypted with an encryption algorithm that uses the identification information of the purchaser terminal as a public key and transmitted from the card management server to the payment confirmation module, and the payment confirmation module may decrypt the payment confirmation request encrypted using the client-side private key.

The payment confirmation module may acquire identification information for confirming payment from the user according to the decrypted payment confirmation request and transmit a payment confirmation message including the acquired identification information to the card management server.

The identification information may include one or more of an electronic signature, a password, a PIN number, and a fingerprint of the user.

According to another aspect of the present disclosure, there is provided a digital card-based payment system including a seller terminal configured to acquire a token from a purchaser terminal desiring to purchase a product and a card management server configured to store and manage one or more pieces of card information and one or more pieces of token information corresponding to the card information and, upon receipt of the token information and payment information for the product from the seller terminal, make payment for the product using card information corresponding to the received token.

The seller terminal may acquire the token from the purchaser terminal by scanning a code displayed on the purchaser terminal, receiving the token from the purchaser terminal through wireless communication with the purchaser terminal, or receiving a character string corresponding to the token displayed on the purchaser terminal from a user of the purchaser terminal.

The card management server may receive a registration message including the card information from the purchaser terminal, generate the token from the card information included in the received registration message, and transmit the generated token to the purchaser terminal.

The registration message may be encrypted with an encryption algorithm that uses a server-side identifier corresponding to the card management server as a public key and transmitted from the purchaser terminal to the card management server.

The server-side identifier may be a network address of the card management server.

When the encrypted registration message is received, the card management server may decrypt the encrypted registration message with a server-side private key corresponding to the server-side identifier.

The card management server may encrypt the token with an encryption algorithm that uses a client-side identifier corresponding to the purchaser terminal as a public key and transmit the encrypted token to the purchaser terminal.

The client-side identifier may include one or more of a phone number allocated to the purchaser terminal, a serial number of the purchaser terminal, and an identity (ID) of the user of the purchaser terminal.

The encrypted token may be decrypted using a client-side private key corresponding to the client-side identifier.

The card management server may request payment for the product by replacing the token received from the seller terminal with card information corresponding to the received token and transmitting the replaced card information and the payment information to a card company server.

The card management server may encrypt the payment confirmation request with an encryption algorithm that uses a client-side identifier corresponding to the purchaser terminal as a public key.

The card management server may transmit a payment confirmation request to the purchaser terminal when a payment approval message is received from the card company server according to the payment request and determine that the payment for the product is successful when a payment confirmation message is received from the purchaser terminal in a predetermined time.

The payment confirmation message may include one or more of an electronic signature, a password, a PIN number, and a fingerprint of the user of the purchaser terminal.

According to still another aspect of the present disclosure, there is provided a method of generating a token in a digital card-based payment system, the method including: receiving, by a card management server, a registration message including card information from a purchaser terminal; generating, by the card management server, a token from the card information included in the received registration message; and transmitting, by the card management server, the generated token to the purchaser terminal.

The registration message may be encrypted with an encryption algorithm that uses a server-side identifier corresponding to the card management server as a public key and transmitted from the purchaser terminal to the card management server.

The server-side identifier may be a network address of the card management server.

The receiving of the registration message may further include decrypting the encrypted registration message with a server-side private key corresponding to the server-side identifier.

The token generation method may further include encrypting, by the card management server, the token with an encryption algorithm that uses a client-side identifier corresponding to the purchaser terminal as a public key before the transmitting of the token.

The client-side identifier may include one or more of a phone number allocated to the purchaser terminal, a serial number of the purchaser terminal, and an identity (ID) of the user of the purchaser terminal.

The encrypted token may be decrypted using a client-side private key corresponding to the client-side identifier.

According to yet another aspect of the present disclosure, there is provided a digital card-based payment method including acquiring, by a seller terminal, a token from a purchaser terminal desiring to purchase a product, receiving, by a card management server, the token and payment information for the product from the seller terminal, and making payment for the product using card information corresponding to the received token.

The acquiring of the token may be performed by scanning a code displayed on the purchaser terminal, receiving the token from the purchaser terminal through wireless communication with the purchaser terminal, or receiving a character string corresponding to the token displayed on the purchaser terminal from a user of the purchaser terminal.

The making of payment for the product may further include replacing the token received from the seller terminal with card information corresponding to the received token and transmitting the replaced card information and the payment information to a card company server.

The card management server may transmit a payment confirmation request to the purchaser terminal when a payment approval message is received from the card company server according to the transmitted payment request and determine that the payment for the product is successful when a payment confirmation message is received from the purchaser terminal in a predetermined time.

The card management server may encrypt the payment confirmation request with an encryption algorithm using a client-side identifier corresponding to the purchaser terminal as a public key.

The payment confirmation message may include one or more of an electronic signature, a password, a PIN number, and a fingerprint of the user of the purchaser terminal.

### BRIEF DESCRIPTION OF THE DRAWINGS

The above and other objects, features, and advantages of the present disclosure will become more apparent to those of ordinary skill in the art by describing in detail exemplary embodiments thereof with reference to the accompanying drawings, in which:

FIG. 1 is a block diagram for describing a digital card-based payment system 100 according to an embodiment of the present disclosure;

FIG. 2 is a block diagram illustrating a detailed configuration of a purchaser terminal 102 according to an embodiment of the present disclosure;

FIG. 3 is a block diagram illustrating a detailed configuration of a seller terminal 104 according to an embodiment of the present disclosure;

FIG. 4 is a block diagram illustrating a detailed configuration of a card management server 106 according to an embodiment of the present disclosure;

FIG. 5 is a flowchart for describing a digital card generation method 500 according to an embodiment of the present disclosure; and

FIG. 6 is a flowchart for describing a digital card-based payment method 600 according to an embodiment of the present disclosure.

### DETAILED DESCRIPTION OF EXEMPLARY EMBODIMENTS

Hereinafter, embodiments of the present disclosure will be described in detail with reference to the accompanying drawings. However, these embodiments are only exemplary, and the present disclosure is not limited thereto.

In describing the present disclosure, when it is determined that a detailed description of known techniques associated with the present disclosure may unnecessarily obscure the gist of the present disclosure, the detailed description thereof will be omitted. Also, the terms described below are defined in consideration of the functions in the present disclosure, and thus may vary depending on a user, intention of an operator, or custom. Accordingly, the definition would be made on the basis of the whole specification.

The technical scope of the present disclosure is defined by the claims, and the following embodiments are intended only to explain the technical scope of the present disclosure to those who skilled in the art.

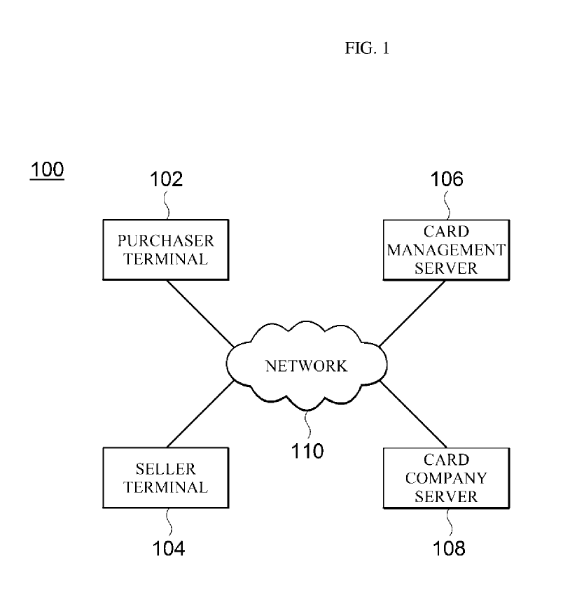

FIG. 1 is a block diagram for describing a digital card-based payment system 100 according to an embodiment of the present disclosure. As shown in FIG. 1, the digital card-based payment system 100 according to an embodiment of the present disclosure includes a purchaser terminal 102, a seller terminal 104, a card management server 106, and a card company server 108, which are connected over a network 110 and configured to transmit and receive a message.

The purchaser terminal 102 is a terminal that is used by a user/purchaser who desires to purchase a product or service (hereinafter, collectively referred to as a “product”). The purchaser terminal 102 may be a personal mobile device including, for example, a mobile phone, a smartphone, a tablet, a notebook, and a desktop PC. The purchaser terminal 102 receives personal information and card information from the user, delivers the personal information and card information to the card management server 106, receives a token corresponding to the card information from the card management server 106, and stores the received token. The term “token” used herein means a character string that is generated and managed according to card information of a user. That is, in the embodiment of the present disclosure, one token is generated corresponding to one piece of card information, and is stored and managed to be matched with the card information. The generation and management of the token may be performed by the card management server 106 which will be described later. That is, the purchaser terminal 102 may store therein only the token corresponding to the card information rather than the card information itself and use the token instead of the card information, thus increasing security during a payment process.

The purchaser terminal 102 may convert the received token to a form of a visually recognizable code to store the converted form. The code may be, for example, a barcode, a QR code, or a visualized figure having a similar form. As described above, the token which has been converted to the code is used instead of the card information when the user desires to purchase a specific product.

The seller terminal 104 is a terminal that is used by a seller who desires to sell a product or service. The seller terminal 104 may be, for example, a point of sale (POS) terminal that is provided in a shop.

The seller terminal 104 acquires a token from the purchaser terminal 102 which desires to purchase a product and transmits the acquired token and payment information on the desired product to the card management server 106 to request payment of the product. In an embodiment, the seller terminal 104 may acquire the token from the purchaser terminal 102 by scanning a code (for example, a visually recognizable code such as a barcode or QR code) that is displayed on a screen of the purchaser terminal 102. In this case, the seller terminal 104 may include an appropriate scanning means for recognizing the code.

In another embodiment, the seller terminal 104 may acquire the token from the purchaser terminal 102 via wireless data communication with the purchaser terminal 102. For example, the seller terminal 104 may include a wireless data communication means such as near field communication (NFC), wireless LAN, and Bluetooth, and may receive the token from the purchaser terminal 102 using the wireless data communication means. Alternatively, the seller terminal 104 may acquire the token by directly receiving a character string corresponding to the token from the purchaser. In this case, the seller terminal 104 may include an appropriate input means (for example, a keyboard or touch interface) for receiving the character string from the purchaser.

The card management server 106 stores and manages one or more pieces of card information registered from users who use a digital card-based payment service and one or more pieces of token information corresponding to the card information. Specifically, the card management server 106 receives a registration message including card information and personal information of the purchaser from the purchaser terminal 102, generates a token from the card information included in the received registration message, and then stores a pair of the card information and the generated token. In this case, the token may be generated by converting the card information using a predetermined random function. In addition, the card management server 106 may transmit the generated token to the purchaser terminal 102, thereby allowing the purchaser terminal 102 to make payment using the token instead of the card information during the payment process.

In an embodiment, message communication between the purchaser terminal 102 and the card management server 106 may be encrypted by an ID-based public-key encryption/decryption algorithm. The ID-based public-key encryption/decryption algorithm is an algorithm for performing encryption and decryption using a pair of a public key and a private key, the public key being a specific identifier such as an e-mail, a phone number, a network address (an IP address), and so on. For example, the purchaser terminal 102 may generate the pair of the public key and the private key based on its phone number, and the card management server 106 may generate the pair of the public key and the private key based on its IP address. However, the above description is meant to be exemplary only, and the purchaser terminal 102 and the card management server 106 may generate the pair of the public key and the private key using other information for identification other than the above phone number and IP address.

In an embodiment, the registration message may be encrypted with an encryption algorithm that uses a server-side identifier of the card management server 106 as the public key and then transmitted from the purchaser terminal 102 to the card management server 106. The purchaser terminal 102 may acquire the server-side identifier from the card management server 106, encrypt the registration message using the server-side identifier, and transmit the encrypted registration message to the card management server 106. In this case, the server-side identifier may be a network address (IP address, etc.) of the card management server 106. When the encrypted registration message is received, the card management server 106 may decrypt the encrypted registration message with a server-side private key corresponding to the server-side identifier.

In addition, even when the token is transmitted from the card management server 106 to the purchaser terminal 102, a similar algorithm may be applied. Specifically, the card management server 106 may encrypt the generated token with an encryption algorithm that uses a client-side identifier corresponding to the purchaser terminal 102 as a public key, and transmit the encrypted token to the purchaser terminal 102. In this case, the client-side identifier may be a phone number that is allocated to the purchaser terminal 102. The purchaser terminal 102 may decrypt the encrypted token using a client-side private key corresponding to the client-side identifier.

When the token and the product payment information are received from the seller terminal 104, the card management server 106 performs payment for the product using card information corresponding to the received token. Specifically, the card management server 106 replaces the token received from the seller terminal 104 with card information corresponding to the received token and transmits the replaced card information and the payment information to the card company server 108, thereby requesting the payment for the product from the card company server 108.

The card company server 108 is managed by a card company that provides a digital card to the purchaser terminal 102. The term “card” used herein means all kinds of payment means that are used instead of cash, such as a credit card, a debit card, and a prepaid card. The card company server 108 receives a payment request message including card information and payment information from the card management server 106 and makes payment according to the payment request message. When the payment is successfully made, the card company server 108 transmits a payment approval message to the card management server 106.

When a payment approval message according to the payment request is received from the card company server 108, the card management server 106 transmits a payment confirmation request to the purchaser terminal 102. If the payment confirmation message is received from the purchaser terminal 102 in a predetermine time, the card management server 106 determines that the payment for the product has been successful. In this case, the payment confirmation message may include one or more of an electronic signature, a password, a PIN number, and a fingerprint of the user of the purchaser terminal 102. On the contrary, if the payment confirmation message is not received from the purchaser terminal 102 or the payment approval message is not received from the card company server 108, the card management server 106 determines that the payment for the product has been failed.

The network 110 mediates data communication between the above described purchaser terminal 102, the seller terminal 104, the card management server 106, and the card company server 108. The term “network” used herein means all kinds of communication networks capable of packet data communication, such as a mobile communication network, a wired/wireless Internet network, etc.

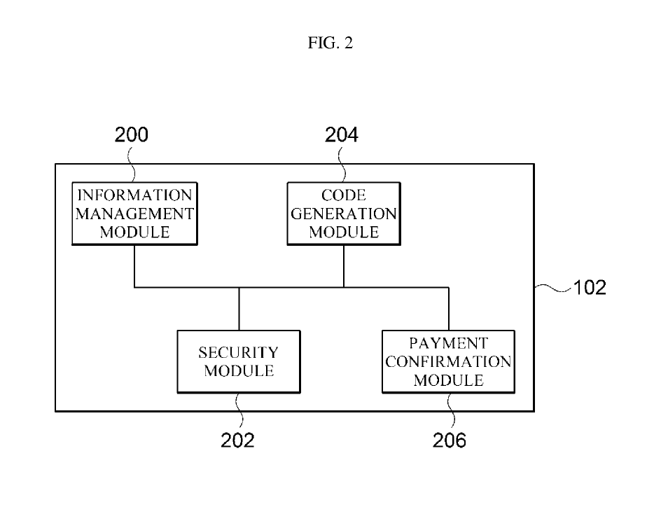

FIG. 2 is a block diagram illustrating a detailed configuration of the purchaser terminal 102 according to an embodiment of the present disclosure. As shown in FIG. 2, the purchaser terminal 102 according to an embodiment of the present disclosure includes an information management module 200, a security module 202, a code generation module 204, and a payment confirmation module 206.

The information management module 200 receives user information needed for the user of the purchaser terminal 102 to subscribe to and register for a digital card service. Specifically, the information management module 200 receives user information needed to generate a digital card from the user of the purchaser terminal 102 and manages the user information. The user information includes personal information such as a user ID, a password, a phone number, an address, and the like and card information such as a card number, an issue date, a type, a CVC number, and the like. To this end, the information management module 200 may include an appropriate user interface for receiving the user information from the user.

As described above, the term “card” used herein means all kinds of payment means, such as a credit card, a debit card, and a prepaid card. The received user information is converted to a form of a message encrypted by a below-described security module 202 and is transmitted to the card management server 106.

The security module 202 is a module for encrypting and decrypting data transmitted between the purchaser terminal 102 and the card management server 106. As described above, in the embodiment of the present disclosure, the data is encrypted and decrypted using the ID-based public key infrastructure.

When sensitive data such as user information is transmitted from the purchaser terminal 102 to the card management server 106, the security module 202 encrypts a message using a public key (server-side public key), for example a server IP address value, of the card management server 106 acquired from the card management server 106. In addition, in order to receive encrypted data from the card management server 106, the security module 202 generates a pair of a public key and a private key, the public key (client-side public key) being identification information of the purchaser terminal 102, for example, a phone number of the purchaser terminal 102, and registers the generated public key in a public key storage unit 406 of the card management server 106. The encrypted data includes user information registration data that is transmitted from the purchaser terminal 102 to the card management server 106 when subscribing to a digital card service, token data that is transmitted from the card management server 106 to the purchaser terminal 102 in order to generate a code, payment information data that is transmitted from the seller terminal 104 to the card management server 106 upon payment by card, payment approval data that is needed to check payment by a user, and so on.

The code generation module 204 receives a token that is matched with the card information received through the information management module 200 from the card management server 106 and converts the token to a visually recognizable code such as a barcode or QR code being a two-dimensional barcode. As described above, the user information including the card information is transmitted to the card management server 106 for subscription to a service. In this case, the card management server 106 generates a token corresponding to the received card information and provides the generated token to the purchaser terminal 102. Then, the code generation module 204 converts the token to a code such as a barcode or QR code. That is, in the embodiment of the present disclosure, an actual card number is not stored in the purchaser terminal 102 or used for card payment. Instead, the token may be stored and then utilized for payment, thereby providing safer financial transactions.

When payment for a product is made using the generated code, the payment confirmation module 206 generates a payment confirmation message for dual authentication (identification and non-repudiation of a person who requests a card transaction), and transmits the generated payment confirmation message to the card management server 106. When product information and payment information are received from the seller terminal 104 upon request of a card transaction, the card management server 106 receives a payment approval message from the card company server 108 and then delivers a payment confirmation request message to the payment confirmation module 206. As described above, the payment confirmation request is encrypted using a phone number of the purchaser terminal 102 as the public key, decrypted by the security module 202, and delivered to the payment confirmation module 206. The payment confirmation module 206 requests payment confirmation by displaying product information and payment information included in the received payment confirmation request to a user. The payment confirmation request is encrypted with an encryption algorithm that uses identification information (a phone number, etc.) of the purchaser terminal 102 as a public key and transmitted from the card management server 106 to the payment confirmation module 206. The payment confirmation module 206 may decrypt the encrypted payment confirmation request using a client-side private key that is generated from the identification information of the purchaser terminal 102. The user confirms the displayed payment information and then informs that the payment has been made according to his/her agreement by entering a means for verifying his/her identity, for example, his/her electronic signature, password, PIN number, fingerprint, etc. The identity verification information that is entered by the user is encrypted along with the payment confirmation message and transmitted to the card management server 106. Thus the transaction is completed.

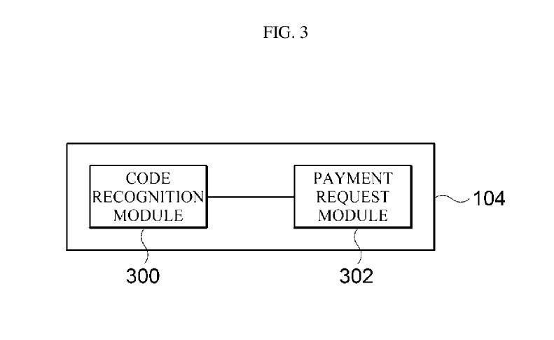

FIG. 3 is a block diagram illustrating a detailed configuration of the seller terminal 104 according to an embodiment of the present disclosure. As described above, the seller terminal 104 may be a POS device including a scanning function for a barcode or QR code, an automatic calculation and counting function for payment details, and a stock management function. As shown in FIG. 3, the seller terminal 104 according to an embodiment of the present disclosure includes a code recognition module 300 and a payment request module 302.

The code recognition module 300 acquires a token for payment from the purchaser terminal 102. For example, the code recognition module 300 may be configured to acquire the token by recognizing a barcode or QR code displayed on a screen of the purchaser terminal 102 and converting the barcode or QR code to the token. In addition, the code recognition module 300 according to an embodiment of the present disclosure may receive the token through wireless communication from the purchaser terminal 102 or directly receive the token from the purchaser.

The payment request module 302 is a module for requesting a card payment by delivering, to the card management server 106, the token acquired from the code recognition module 300 and the payment information received from the seller.

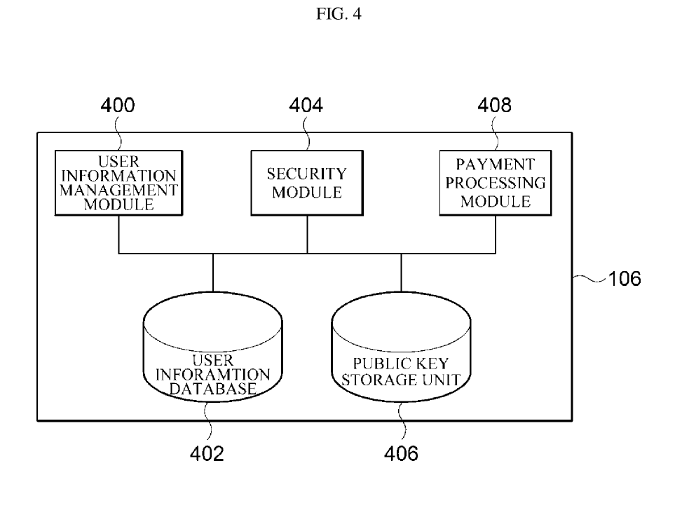

FIG. 4 is a block diagram illustrating a detailed configuration of the card management server 106 according to an embodiment of the present disclosure. As shown in FIG. 4, the card management server 106 according to an embodiment of the present disclosure includes a user information management module 400, a user information database 402, a security module 404, the public key storage unit 406, and a payment processing module 408.

The user information management module 400 receives a registration message containing the personal information and card information entered by the user upon service subscription and builds a database thereof. As described above, the registration message is encrypted by the purchaser terminal 102 and then received. The received message is decrypted by the security module 404 and then delivered to the user information management module 400.

The user information management module 400 uses a predetermined token generation function such as a random function to generate any token that may be substituted for a card number included in the registration message, stores a pair of the token and the card number in addition to the user information in the user information database 402, and delivers the token to the purchaser terminal 102. In an embodiment of the present disclosure, the token may be a character string including a character or a number having a predetermined length, but the present disclosure is not limited to a specific form of token.

The user information database 402 is a database for storing and managing the above-described pair of the token and the card number along with the user information.

The security module 404 encrypts or decrypts data that is transmitted or received between the purchaser terminal 102 and the card management server 106. As described above, when a message that is encrypted using a server IP address value being a public key of the card management server 106 is received, the security module 404 decrypts the received message using a private key that is a pair with the public key. In addition, the security module 404 uses a phone number being a public key of the purchaser terminal 102 to deliver the encrypted message to the purchaser terminal 102.

The public key storage unit 406 stores a public key of the purchaser terminals 102 and a public key of the card management server 106. The security module 202 of the purchaser terminal 102 may acquire the public key of the card management server 106 by searching the public key storage unit 406. Likewise, the security module 404 of the card management server 106 may acquire the public key of the purchaser terminal 102 by searching the public key storage unit 406.

The payment processing module 408 replaces token data delivered along with payment information with user card information upon request of payment by the seller terminal 104 and transmits the replaced card information and the payment information to the card company server 108 to request payment approval. Subsequently, when a payment approval message is delivered from the card company server 108, the payment processing module 408 transmits a payment confirmation message to the purchaser terminal 102 in order to confirm the transaction. When a confirmation message including identification information on the user is received as a response to the payment confirmation message from the purchaser terminal 102, the payment processing module 408 transmits a payment completion message indicating completion of the transaction to the purchaser terminal 102 and the seller terminal 104. If the confirmation message is not received from the user in a predetermined time, the payment processing module 408 requests cancellation of the payment from the card company server 108 and transmits an approval rejection message to the purchaser terminal 102 and the seller terminal 104.

As such, the digital card-based payment system according to an embodiment of the present disclosure may generate token data that may be substituted for the card number, convert the generated token to an encrypted code, and use the encrypted code upon payment, thus minimizing card-related risks which are caused by loss and hacking. In addition, the digital card-based payment system according to an embodiment of the present disclosure may encrypt data transferred between systems using the ID-based encryption technique, thus minimizing a delay time caused by complicated public key authentication, and may also transmit the encrypted message only to a registered purchaser terminal 102 upon approval of payment and thereby perform final payment approval through confirmation of user identification and payment, thus providing a benefit of non-repudiation. Furthermore, the digital card-based payment system may initially generate a code and then continuously reuse the generated code, unlike a conventional technique in which a new code is generated whenever payment is made, thus reducing an additional manipulation process of a user that is required in a payment stage and thereby improving user convenience.

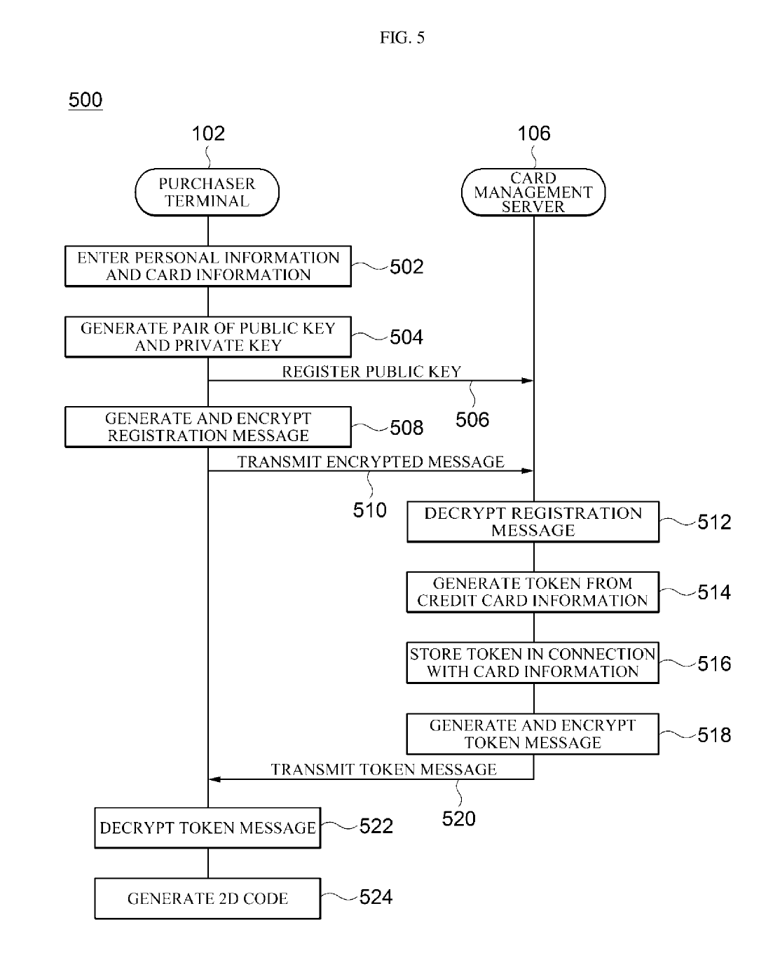

FIG. 5 is a flowchart for describing a digital card generation method 500 according to an embodiment of the present disclosure.

First, a user enters personal information and card information through an information input window on a purchaser terminal 102 (502).

A security module 202 generates a pair of a public key and a private key, the public key being a phone number of the purchaser terminal 102 among the entered information and enabling only the user to perform decryption (504). The generated public key is registered and stored in a public key storage unit 406 within a card management server 106 (506).

Next, an information management module 200 of the purchaser terminal 102 generates a registration message including the entered personal information and card information, and the security module 202 encrypts the generated registration message with a public key (a server-side public key) of the card management server 106 (508) and then transmits the encrypted registration message to the card management server 106 (510).

A security module 404 of the card management server 106 decrypts the received registration message with its private key (512), and delivers the decrypted message to a user information management module 400.

The user information management module 400 uses a token generation function such as a random function to generate a token that is to be replaced with credit card information stored in the decrypted message (514), and stores a pair of the generated token and the card number in a user information database (516).

Subsequently, the security module 404 encrypts a token message including the token information with a public key of the purchaser terminal 102 (518) and transmit the encrypted token message to the purchaser terminal 102 (520). Then, the security module 202 of the purchaser terminal 102 decrypts the token message with its own private key (522) and delivers the decrypted token message to a code generation module 204.

Lastly, the code generation module 204 generates a code using the received token and stores the generated code in a memory of the purchaser terminal 102 (524).

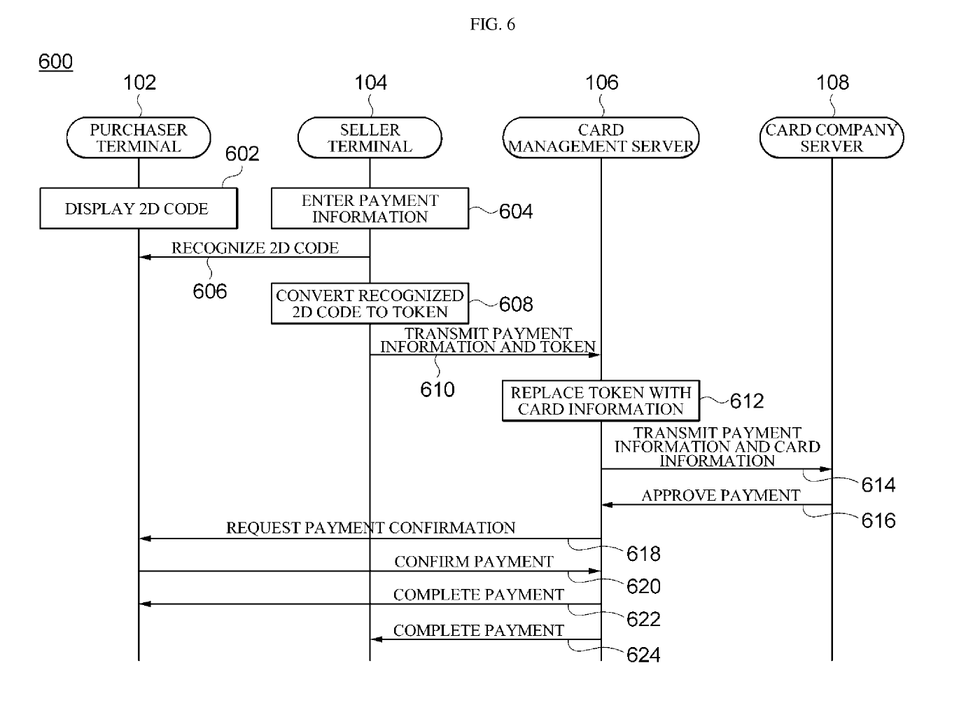

FIG. 6 is a flowchart for describing a digital card-based payment method 600 according to an embodiment of the present disclosure.

First, a user presents a code, such as a barcode or QR code, that is obtained by digitalizing a card stored in a purchaser terminal 102 in order to pay for a product (602).

A seller of the product uses a seller terminal 104 to enter product information and payment information such as a payment amount (604) and recognizes the code that is displayed on the purchaser terminal 102 (606). The recognized code is converted to a token by a code recognition module 300 of the seller terminal 104 (608).

Subsequently, the seller terminal 104 encrypts the token along with the product information and the payment information and transmits a message including the encrypted token, product information, and payment information to a card management server 106 (610). Then, when the message is received, the card management server 106 decrypts the received message and replaces a token included in the decrypted message with card information matched with the token (612).

Next, the card management server 106 builds a message of the replaced card information and the payment information and transmits the message to a card company server 108 to approve payment (614). When the payment approval is completed by the card company server 108 (616), the card management server 106 transmits a payment confirmation request message to the purchaser terminal 102 (618).

When the payment confirmation request is received, the user confirms payment details displayed on the purchaser terminal 102, verifies the user's identity using one of his/her electronic signature, password, PIN number, and fingerprint, and pushes an OK button to transmit a payment confirmation message to the card management server 106 (620).

When the payment confirmation message is normally received, the card management server 106 transmits an approval completion message to the purchaser terminal 102 and the seller terminal 104 (618 and 620). However, when the confirmation message is not normally received in a predetermined time, the card management server 106 requests cancellation of the payment from the card company server 108 and transmits an approval rejection message to both the purchaser terminal 102 and the seller terminal 104. Thus, the transaction is completed.

According to embodiments of the present disclosure, card information for payment may not be stored in a purchaser's terminal, and a barcode or QR code may be generated based on any token data that is matched with the card information rather than actual card information, thus minimizing information leakage when the card information is copied or stolen.

In addition, according to embodiments of the present disclosure, data related to payment may be encrypted using an ID-based encryption technique and delivered upon approval of the payment, thus minimizing security risks upon payment. In addition, a phone number of a terminal may be utilized as a public key for the encryption, and thereby payment approval is allowed only using the purchaser terminal (that is, a terminal having a corresponding phone number) that is authenticated when a corresponding code is generated, though the code is copied and a payment attempt is made by another purchaser terminal, thus blocking a malicious payment attempt.

Furthermore, according to embodiments of the present disclosure, dual authentication may be performed through a user's request and confirmation upon payment approval, thus providing a non-repudiation function.

Embodiments of the present disclosure may include a computer-readable storage medium including a program for performing methods described in this specification on a computer. The computer-readable recording medium may include a program instruction, a local data file, a local data structure, or a combination thereof. Examples of the computer-readable recording medium include a magnetic medium, such as a hard disk, a floppy disk, and a magnetic tape, an optical recording medium, such as a CD-ROM, a DVD, etc., a magneto-optical medium such as a floptical disk, and a hardware device specially configured to store and perform a program instruction, such as a ROM, a RAM, a flash memory, etc. Examples of the program instruction include a high-level language code executable by a computer with an interpreter, in addition to a machine language code made by a compiler.

Although the disclosure has been described with reference to exemplary embodiments, it will be understood by those skilled in the art that various changes may be made without departing from the spirit or scope of the present disclosure.

Thus, the scope of the present disclosure is to be determined by the following claims and their equivalents, and shall not be restricted or limited by the foregoing detailed description.

What is claimed is:

1. A purchaser terminal comprising:
an information management module configured to receive user payment card information and to transmit the user payment card information to a card management server;
a code generation module configured to receive from the card management server a token corresponding to the user payment card information, to use the received token to generate a code, and provide the generated code to a seller terminal; and
a payment confirmation module configured to perform a user payment confirmation process in response to a payment confirmation request of the card management server after payment for a product is attempted by providing the generated code to the seller terminal.

2. The purchaser terminal of claim 1, wherein the code generation module is further configured to provide the generated code to the seller terminal as one of: a visually recognizable code displayed on a screen, and a generated code transmitted to the seller terminal through wireless communication.

3. The purchaser terminal of claim 1, further comprising a security module configured to encrypt a transmission message, to be transmitted to the card management server, with an encryption algorithm that uses identification information of the card management server as a public key, and to decrypt a reception message, received from the card management server, using a client-side private key generated from identification information of the purchaser terminal.

4. The purchaser terminal of claim 3, wherein the identification information of the card management server includes one or more of a network address of the card management server, a serial number of the card management server, and a network identity (ID) of the card management server.

5. The purchaser terminal of claim 3, wherein the identification information of the purchaser terminal includes one or more of a phone number of the purchaser terminal, a serial number of the purchaser terminal, and an identity (ID) of the user.

6. The purchaser terminal of claim 3, wherein:
the payment confirmation request is encrypted with an encryption algorithm using the identification information of the purchaser terminal as a public key, and transmitted from the card management server to the payment confirmation module, and
the payment confirmation module decrypts the payment confirmation request encrypted using the client-side private key.

7. The purchaser terminal of claim 6, wherein the payment confirmation module is further configured to acquire as user input identification information for confirming payment, based on the decrypted payment confirmation request and to transmit a payment confirmation message, including the acquired identification information, to the card management server.

8. The purchaser terminal of claim 7, wherein the identification information includes one or more of an electronic signature, a password, a PIN number, and a user fingerprint.

9. A digital card-based payment system comprising:
a seller terminal configured to acquire a token from a purchaser terminal in relation to a purchase of a product; and
a card management server configured to store and manage one or more pieces of card information and one or more pieces of token information corresponding to the card information;
the card management server being further configured to receive the token information and payment information related to the product from the seller terminal;
the card management server being further configured to implement payment for the product using one of the pieces of stored card information corresponding to the received token information.

10. The digital card-based payment system of claim 9, wherein the seller terminal is further configured to acquire the token from the purchaser terminal by one of:
scanning a visually recognizable code displayed on the purchaser terminal,
receiving the token via wireless communication with the purchaser terminal, and
receiving at the seller terminal, a user character string corresponding to the token.

11. The digital card-based payment system of claim 9, wherein the card management server is further configured to receive from the purchaser terminal a registration message including the card information, to generate the token from the card information included in the received registration message, and to transmit the generated token to the purchaser terminal.

12. The digital card-based payment system of claim 11, wherein the registration message is encrypted with an encryption algorithm using, as a public key, a server-side identifier corresponding to the card management server and is transmitted from the purchaser terminal to the card management server.

13. The digital card-based payment system of claim 12, wherein the server-side identifier is a network address of the card management server.

14. The digital card-based payment system of claim 11, wherein the card management server is further configured to respond to reception of the encrypted registration message by decrypting the encrypted registration message with a server-side private key corresponding to the server-side identifier.

15. The digital card-based payment system of claim 11, wherein the card management server is further configured to encrypt the token with an encryption algorithm using, as a public key, a client-side identifier corresponding to the purchaser terminal and to transmits the encrypted token to the purchaser terminal.

16. The digital card-based payment system of claim 15, wherein the client-side identifier includes one or more of a phone number allocated to the purchaser terminal, a serial number of the purchaser terminal, and an identity (ID) of the user of the purchaser terminal.

17. The digital card-based payment system of claim 16, wherein the encrypted token is decrypted with a client-side private key corresponding to the client-side identifier.

18. The digital card-based payment system of claim 9, wherein the card management server is further configured to implement payment for the product by replacing the token received from the seller terminal with card information corresponding to the received token, and to transmit the replaced card information and the payment information to a card company server.

19. The digital card-based payment system of claim 18, wherein:
the card management server is configured to receive a payment approval message, from the card company server, corresponding to the payment request;
the card management server is further configured to transmit a payment confirmation request to the purchaser terminal when the payment approval message is received; and
the card management server is further configured to determine that the payment for the product is successful when a payment confirmation message is received from the purchaser terminal within a predetermined time.

20. The digital card-based payment system of claim 19, wherein the card management server is further configured to encrypt the payment confirmation request with an encryption algorithm that uses, as a public key, a client-side identifier corresponding to the purchaser terminal.

21. The digital card-based payment system of claim 19, wherein the payment confirmation message includes one or more of an electronic signature, a password, a PIN number, and a user fingerprint.

22. A method of generating a token in a digital card-based payment system, the method comprising:
receiving, by a card management server, an encrypted registration message including card information from a purchaser terminal;
decrypting, by the card management server, the encrypted registration message with a server-side private key;
generating, by the card management server, a token from the card information included in the received decrypted registration message;
encrypting, by the card management server, the generated token with an encryption algorithm using, as a public key, a client-side identifier corresponding to the purchaser terminal, to generate an encrypted token; and
transmitting, by the card management server, the encrypted token to the purchaser terminal.

23. The method of claim 22, further comprising:
encrypting the registration message with an encryption algorithm using, as a public key, a server-side identifier corresponding to the card management server;
transmitting the registration message from the purchaser terminal to the card management server; and
decrypting the encrypted token with a client-side private key corresponding to a client-side identifier.

24. The method of claim 23, further comprising using, as the server-side identifier, a network address of the card management server, and
using, as the client-side identifier, one or more of a phone number allocated to the purchaser terminal, a serial number of the purchaser terminal, and an identity (ID) of the user of the purchaser terminal.

25. A digital card-based payment method comprising:
acquiring, by a seller terminal, a token from a purchaser terminal in relation to a purchase of a product;
receiving, by a card management server, the token and payment information related to the product from the seller terminal;
replacing, by the card management server, the token received from the seller terminal with card information corresponding to the received token; and
transmitting, by the card management server, the replaced card information and the payment information to a card company server to implement payment for the product,
wherein the acquiring of the token comprises one of:
acquiring the token from the purchaser terminal by scanning a visually recognizable code displayed on the purchaser terminal,
receiving the token through wireless communication with the purchaser terminal, and
receiving at the seller terminal, a user character string corresponding to the token.

26. The digital card-based payment method of claim 25, further comprising:
receiving, at the card management server, a payment approval message from the card company server, in relation to the transmitted payment request;
transmitting, from the card management server, a payment confirmation request to the purchaser terminal when the payment approval message is received
receiving, from the purchaser terminal, a payment confirmation message;
determining, at the seller terminal, that the payment for the product is successful in response to receiving the payment confirmation message within a predetermined time, and
encrypting the payment confirmation request, at the card management server, with an encryption algorithm using, as a public key, a client-side identifier corresponding to the purchaser terminal, and
including in the payment confirmation message includes one or more of an electronic signature, a password, a PIN number, and a user fingerprint.
